(19) United States
(12) Patent Application Publication
(10) Pub. No.: US 2019/0359861 A1
(43) Pub. Date: Nov. 28, 2019

(54) FILM BACKINGS FOR STRETCH RELEASE MOUNTING

(71) Applicant: 3M INNOVATIVE PROPERTIES COMPANY, St. Paul, MN (US)

(72) Inventors: Michael B. Runge, Stillwater, MN (US); Gerald S. Deeb, Mendota Heights, MN (US); Brett P. Krull, Saint Anthony, MN (US)

(21) Appl. No.: 16/482,404

(22) PCT Filed: Jan. 26, 2018
(86) PCT No.: PCT/US2018/015400

§ 371 Date: Jul. 31, 2019

Related U.S. Application Data
(60) Provisional application No. 62/453,332, filed on Feb. 1, 2017.

(51) Int. Cl. C09J 7/29; C09J 7/30; B32B 7/06; B32B 27/30; B32B 27/32; B32B 25/14; B32B 27/08; B32B 25/08; B32B 25/16

(52) U.S. Cl. CPC C09J 7/29; A47G 1/175; B32B 7/06; B32B 27/302; B32B 27/32; B32B 25/14; B32B 27/308; B32B 27/08; B32B 25/08; B32B 25/16; C09J 2409/006; C09J 2433/006; C09J 2423/106; C09J 2423/046; C09J 2453/006; B32B 2255/10; B32B 2255/26; B32B 2405/00; C09J 7/30

(57) ABSTRACT

The present disclosure generally relates to stretch-releasable adhesive articles that are capable of attaching or adhering to a substrate and that can be removed from the substrate without causing damage to the substrate. The present disclosure also generally relates to methods of making and using such adhesive articles.

### RELATED APPLICATION

This application is related to PCT Application PCT/US2017/016039, filed Feb. 1, 2017 (Attorney Docket Number 77508WO004).

### TECHNICAL FIELD

The present disclosure generally relates to stretch-releasable adhesive articles that are capable of attaching or adhering to a substrate and that can be removed from the substrate without causing damage to the substrate. The present disclosure also generally relates to methods of making and using such adhesive articles.

### BACKGROUND

The revolutionary Command® Adhesive Strip products are a line of stretch removable adhesive strips that holds strongly on a variety of surfaces (including painted drywall, wood, and tile) and that remove cleanly—no holes, marks, or sticky residue. In general, these products include a stretch releasable adhesive composition disposed on tape or other backings. These products generally have utility in bonding to various surfaces or substrates for numerous applications. Stretch releasable adhesive products are designed to firmly adhere an article, such as a hook (to hold a picture or an article of clothing) or other decorative or utilitarian element, to a surface (an adherend), yet remove cleanly when pulled away from the architectural surface at a low angle. The clean removal aspect is designed so that a tacky and/or unsightly residue is not left behind on the surface after removal of the stretch release adhesive. During the process of stretch release removal, the adhesive layer typically remains adhered to the tape backing as the backing is stretched, but releases from the surface (adherend).

### SUMMARY

The inventors of the present disclosure sought to make an improved adhesive mounting product. More specifically, the inventors of the present disclosure recognized that the existing commercially available mounting products suffered from various disadvantages. In particular, certain stretch release adhesive article constructions are limited in size by the associated stretch release force necessary to release from an adherend. The stretch release force is typically proportional to the width of the adhesive on the backing and the thickness of the backing, all other constraints held equal. The backing material is often selected by balancing the desired load bearing strength and rupture strength against the stretch release force. Achieving this balance often results in backings having a relatively small width (e.g., 0.625-0.75 inches) and relatively higher length to width aspect ratio. The resultant limitation on adhesive area can reduce the available load bearing strength of the article, and can thus require more strips for a given article to be mounted. Attempts to make wider articles or adjust the aspect ratio typically results in at least one of excess stretch release force and substrate damage on removal. Other constructions eliminate backing materials, but require much greater thickness as a result.

As such, the inventors of the present disclosure sought to formulate mounting products and/or adhesive articles with at least one of a larger adhesive area, that work well on myriad substrates, and/or that are capable of consistently holding higher weights, all without damaging the substrate to which they are applied.

The present disclosure generally relates to adhesive articles that can be released from a substrate without damage. Some embodiments of the adhesive articles include a novel multilayer backing. In some embodiments, the multilayer backing and/or an adhesive article including the multilayer backing is reusable. In some embodiments the backing can be deliberately constructed to reversibly stretch at low forces and recover to substantially its original size and/or shape. In other embodiments, the backing can be deliberately constructed so that at least a portion of the backing is irreversibly stretched and a substantial portion thereof is deformed (i.e., the backing does not recover its original size and shape).

Some embodiments relate to a multilayer backing include a core layer between two skin layers. Some embodiments include a polymeric core layer. Some embodiments include polymeric skin layers.

Some embodiments include an adhesive article comprising a multilayer backing comprising a core layer comprising at least one of an elastomeric material, an elastomeric polymer, SEBS, SEPS, SIS, SBS, polyurethane, ethyl vinylacetate (EVA), ethyl methyl acrylate (EMA) ultra low linear density polyethylene (ULLDPE), hydrogenated polypropylene, and combinations or blends thereof; and a first skin layer comprising at least one of polypropylene, polyethylene, high density polyethylene (HDPE), low density polyethylene (LDPE), linear low density polyethylene (LLDPE), a polyurethane, EVA, EMA, and combinations or blends thereof; and a peelable adhesive adjacent to a major surface of the multilayer backing wherein the backing has a core to skin ratio of between about 2:1 and about 100:1 (core:a single skin); and wherein the backing has a modulus of elasticity and/or a modulus of secant of between about 100 psi and about 15,000 psi as determined by at least one of ASTM D638-14 and ASTM D412-06a. Some embodiments further include a second skin layer comprising at least one of polypropylene, polyethylene, high density polyethylene (HDPE), low density polyethylene (LDPE), linear low density polyethylene (LLDPE), a polyurethane, EVA, and combinations or blends thereof.

As used herein, the term “elastomeric” and “elasticity” shall be interchangeable with the term “elastic” and refers to sheet material, which can be elongated by at least 25 percent of its relaxed length and which will recover, upon release of the applied force, at least 10 percent of its elongation.

Some embodiments include an adhesive article wherein the backing has a thickness of between about 2 mils and about 40 mils. In presently preferred embodiments, the backing has a thickness of no greater than about 20 mils.

In some embodiments, a force of between about 1N and about 50N per inch width results in at 10% strain in tensile elongation as measured according to ASTM D638-14 and/or ASTM D412-06a.

In some embodiments the core has a tensile and/or elastic modulus of between about 50 psi and about 5000 psi.

In some embodiments, at least one of the first or second skin layer has an elastic and/or secant modulus of between about 3000 psi and about 300,000 psi.

In some embodiments, the core comprises at least one of SEBS, SIS, or SBS.

In some embodiments, the core and/or first or second skin layer further including at least one of a tackifier, a plasticizer, a plasticizing oil, a UV inhibitor, and/or an antioxidant.

In some embodiments, the first skin comprises at least one of polypropylene or polyethylene wherein the second skin comprises at least one of polypropylene or polyethylene.

In some embodiments, the adhesive includes at least one of SBS, SBR, SIS, SEBS, acrylate, and/or polyurethane.

In some embodiments, the adhesive includes at least one of the following tackifiers: polyterpene, terpene phenol, rosin esters, hydrocarbons, C5 resins, C9 resins, and/or rosin acids.

In some embodiments, the adhesive includes at least one of an acrylate, a polyurethane, a tackified rubber adhesives, such as natural rubber; olefins; silicones and silicone block copolymers such as silicone polyureas; synthetic rubber adhesives such as polyisoprene, polybutadiene, and styrene-isoprene-styrene, styrene-ethylene-butylene-styrene and styrene-butadiene-styrene block copolymers, SBR, SEBS, and other synthetic elastomers; and tackified or untackified acrylic adhesives such as copolymers of isooctylacrylate and acrylic acid, which can be polymerized by radiation, solution, suspension, or emulsion techniques; polyurethanes; and combinations thereof

In some embodiments the adhesive has a Tg of between about −125 degrees Celsius and about 20 degrees Celsius. In some embodiments the adhesive has a Tg of between about −80 degrees Celsius and about 20 degrees Celsius.

In some embodiments, the backing and/or at least some of the backing layers are substantially optically clear. As used herein, the term “optically clear” means having a light transmission of at least about 50% and/or a haze of no greater than 40%. Some embodiments have a light transmission of at least about 75%. Some embodiments have a haze of no greater than 20%.

### BRIEF DESCRIPTION OF DRAWINGS

FIG. 1 is a schematic drawing of an exemplary multilayer backing as generally described herein.

FIG. 2 is a schematic drawing of the multilayer backing of FIG. 1 in an adhesive article as generally described herein.

FIG. 3 is a schematic drawing of the adhesive article of FIG. 2.

### DETAILED DESCRIPTION

Various embodiments and implementations will be described in detail. These embodiments should not be construed as limiting the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

In some embodiments, the adhesive articles of the present disclosure can be removed from a substrate or surface without causing damage. As used herein, the term “without causing damage” or “damage-free” or the like means the adhesive article can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

The present disclosure generally relates to adhesive articles that can be stretch removed from a substrate without damage. The adhesive articles of the present disclosure include a rupture resistant, relatively lower stiffness film backing that provides enhanced flexibility to the adhesive article. In some instances, this enhanced flexibility permits the stretch releasable adhesive products to hold more weight at a relatively reduced thickness. In some embodiments, the backing described herein allow for a substantial increase in the size of an adhesive area on an adhesive product while maintaining a) user acceptable stretch release force; and b) damage-free removal. The increase in available adhesive area on a given adhesive article can result in a proportional increase in the amount of weight (by, for example, a mounted hook) that can be held when the article is adhered or attached to a substrate or surface relative to prior art adhesive mounting articles. In some embodiments, the backing increases or enhances the product performance on certain surfaces (e.g., rough or textured surfaces such as, for example, wallpaper, drywall, etc.).

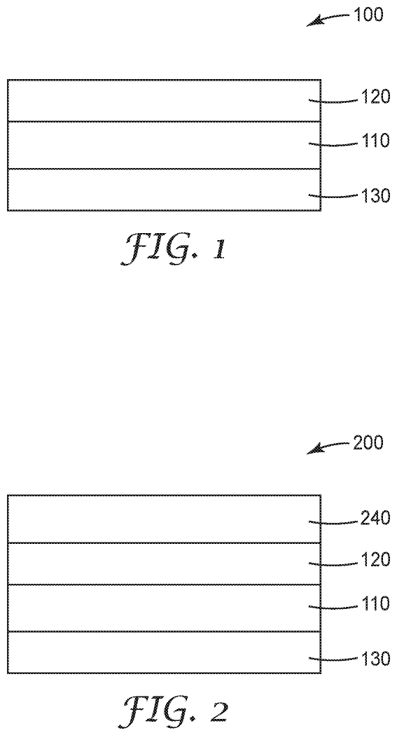

FIG. 1 is a schematic drawing of an exemplary multilayer backing 100 as generally described herein. A multilayer backing can be defined as a backing with two or more layers wherein any individual layer can be a multilayer construction of two or more layers itself. Backing 100 include a core layer 110 between a first skin layer 120 and a second skin layer 130. First and second skin layers 120 and 130, respectively, can the same or different.

The core layer of backing 100 can include at least one of an elastomeric material, a plastomer, an elastomeric polymer, SEBS, SEPS, SIS, SBS, polyurethane, ethyl vinylacetate (EVA), ethyl methyl acrylate (EMA), ultra low linear density polyethylene (ULLDPE), polypropylene, polypropylene copolymers, and combinations or blends thereof. Suitable, commercially available materials for use in the core layer include: KRATON D1114, a styrene-isoprene-styrene block copolymer (SIS) available KRATON Performance Polymers, Inc., Houston, Tex.; EXACT 8201, a metallocene catalyzed ethylene octene alpha olefin copolymer available from Exxon Mobil Corp., Houston, Tex.; KRATON G1657, styrene-ethylene-butylene-styrene block copolymer (SEBS), available from Kraton Performance Polymers; SOLPRENE 1205, a styrene-butadiene rubber (SBR) available from Dynasol Elastomers, Houston, Tex.; and KRATON G1730, a styrene-ethylene-propylene-styrene block copolymer (SEPS), available from KRATON Performance Polymers; and Vistamax 6102, a polypropylene-ethylene copolymer available from Exxon Mobil.

Each of first and second skin layers 120 and 130, respectively, can include at least one of polypropylene, polyethylene, high density polyethylene (HDPE), low density polyethylene (LDPE), linear low density polyethylene (LLDPE), a polyurethane, EVA, EMA, and combinations or blends thereof. Suitable, commercially available materials for use as one or more skin layers include: Optema TC 120, an ethylene methyl acrylate copolymer available from Exxon Mobil; ENGAGE 8450, an ethylene-octene copolymer, available from Dow Chemical Inc., Midland, Mich.; AFFINITY PL 1850G plastomer, an ethylene-octene copolymer available from Dow Chemical; PP1024, a polypropylene homopolymer available from Exxon Mobil; and ESCORENE, EVA polymers available from Exxon Mobil.

In some embodiments, one or both skin layers 120, 130 are more or less elastic than the core layer. In some embodiments, at least one of core and one or more skin layers include a foam. In other embodiments, neither the core nor skin layers include a foam, such that the backing does not include deliberate voids throughout the volume of the constituent films.

In some embodiments, the backing has a modulus of elasticity and/or a modulus of secant of between about 100 psi and about 15,000 psi as determined by at least one of ASTM D638-14 and ASTM D412-06a. In some embodiments, the backing has a module of elasticity and/or a modulus of secant of at least about 200 psi, at least about 400 psi, at least about 600 psi, at least about 1000 psi, at least about 1500 psi, at least about 2500 psi, at least about 500 psi as determined by at least one of ASTM D638-14 and ASTM D412-06a. In the same or different embodiments, the backing has a modulus of elasticity and/or a modulus of secant of no greater than 14,000 psi, of no greater than 13,000 psi, of no greater than 12,000 PSI, and of no greater than 10,000 psi as determined by at least one of ASTM D638-14 and ASTM D412-06a.

In some embodiments, the backing has a Young's modulus of between about 100 psi and about 100,000 psi. In some embodiments, the backing exhibits an elastic recovery of 1-100% at 10% strain as measured by ASTM D5459-95. In some embodiments, the backing exhibits an elastic recovery of 1-100% at 20% strain.

In some embodiments, a force of no greater than about 20N/in is registered by the backing at 50% strain as measured according to ASTM D638-14 and/or ASTM D412-06a. In some embodiments, a force of no greater than about 15N/in is registered at 50% strain as measured according to ASTM D638-14 and/or ASTM D412-06a. In some embodiments, a force of between about 0.5N and about 10N per inch is registered at 50% strain as measured according to ASTM D638-14 and/or ASTM D412-06a.

In some embodiments, the backing can demonstrate a strain at yield (εₒ) (i.e., the strain at the elastic limit or at the onset of plastic deformation) of no greater than about 15%. In other embodiment, the strain at yield is not great than about 12%, or not greater than about 10%.

In some embodiments, the multilayer backing has a core to skin ratio of between about 2:1 and about 300:1 where the ratio represents the thickness of a single core layer to a single skin layer. The ratios depend highly on the multilayer materials as well as the overall thickness of the multilayer film. In one exemplary embodiment, based on a multilayer film composed of a Kraton 1657 core and Engage 8450 skin layers with a total thickness ranging between 6-14 mils, the preferred core/skin ratio would be about 6:1 to about 20:1.

Without wishing to be bound by theory, the core to skin ratio is typically greater in embodiments featuring a foamed core. Such embodiments can include core/skin ratios of no greater than about 300:1, no greater than about 200:1, no greater than about 150:1; or no greater than about 100:1. In embodiments featuring a core that is not foamed (i.e., one that does not include deliberate voids), the core to skin ratio is typically no greater than about 100:1, and in presently preferred circumstances no greater than about 75:1 or no greater than about 50:1.

By changing the ratios of core to skin, both the thickness of the core and skin, as well as their elastic properties, may be varied. In particular, the non-recoverable strain (e.g., plastic deformation) can be reduced in some embodiments by increasing the core to skin ratio (or increased by decreasing the same ratio). This allows for same backing materials to be used in various combinations with selectable impact on the resulting adhesive article. An ability to change the non-recoverable strain in the multilayer backing can allow one to deliberately design, for example, both the stretch release force and the maximum load of an adhesive article. In some embodiments, the backing can non-recoverable strain of no greater than about 20%. In other embodiment, the strain at yield is not great than about 15%, or not greater than about 10%.

In some embodiments, multilayer backings consist of an A/B/A configuration where A represents skin layers and B represents a core layer. In some embodiments, multilayer backings consist of A/B/C configuration where A consists of a skin layer, B consists of a core layer, and C consists of a skin layer of composition different from A.

A backing including a core layer and one or more skin layers can have these layers bonded to one another using any suitable mechanism including, for example, coextruding the core and the skin layer(s), co-molding, extrusion coating, joining through an adhesive composition, joining under pressure, joining under heat, and combinations thereof.

In some embodiments, the backing has a thickness of between about 1 mils and about 40 mils. In some embodiments, the backing has a thickness of greater than 1 mil, greater than 2 mils, greater than 5 mils, greater than 8 mils, greater than 10 mils, greater than 12 mils, greater than 15 mils, greater than 20 mils, greater than 22 mils, or greater than 24 mils. In some embodiments, the backing has a thickness of less than 40 mils, less than 38 mils, less than 35 mils, less than 32 mils, less than 30 mils, less than 28 mils, or less than 25 mils. In presently preferred constructions, the backing has a thickness of at least 5 and not greater than 20 mils.

Some embodiments include dyes or pigments that color at least some or all of the backing layers. Some embodiments include at least one tackifier in at least one layer of the backing. Suitable tackifiers include a rosin, a rosin derivative, a terpene resin, a phenolic resin, a petroleum-based resin, or a combination thereof. In some embodiments, the tackifier is a terpene phenol. Inclusion of a tackifier the one or more of the backing layers can inhibit migration of the adhesive layer or components thereof into the backing.

In certain embodiments, the backing consists of a single layer otherwise meeting the modulus, thickness, and other parameters of the multilayer backings described above. In some embodiments, the single layer film is an isotactic propylene with random ethylene distribution, available, for example, as VISTAMAXX 3980FL or VISTAMAXX 6102 from ExxonMobil Chemical Company, Spring, Tex. Such films can also be used as the core or one or more skin layers.

### Adhesive Articles

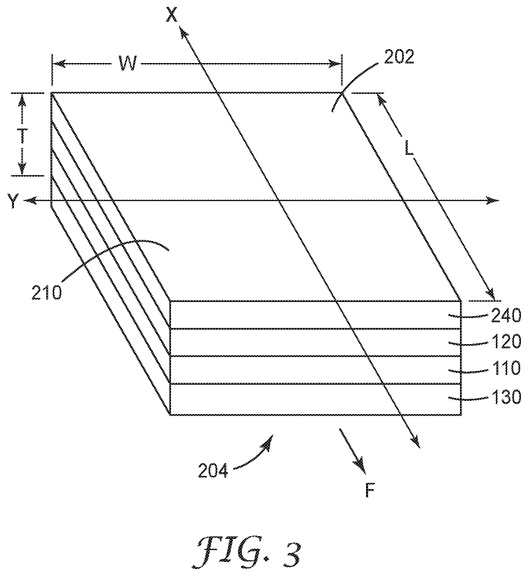

FIGS. 2 and 3 are each a schematic drawing of an exemplary adhesive article 200 as generally described herein. Adhesive article 200 includes backing 100, including a core layer 110 between a first skin layer 120 and a second skin layer 130, and an adhesive layer 240 adjacent to first skin layer 120. The adhesive article includes having first and second opposed major surfaces 202, 204, a thickness “T”, a first major axis X defined by the direction of a stretch force F applied to the article during the stretch release process, a length “L” defined along the first major axis X, a second major axis Y transverse to the first major axis X, and a width “W” defined along the second major axis Y. The first major surface 202 includes an adhesive region 210. In some embodiments, a second adhesive layer (not shown) can be disposed adjacent to second skin layer 130, such that the second major surface 204 also includes an adhesive region.

An available adhesive area on the first major surface 202 is defined by the length “L” and width “W” of the adhesive region 210 (here coextensive with the first major surface 202). Adhesive articles further include a given width W to thickness T ratio as measured in an imaginary plane normal to the first major axis X. The available adhesive area can be at least about 10 square centimeters (cm²), at least about 50 cm², at least about 100 cm², at least about 150 cm², or at least about 1000 cm². Depending on the particular end use application, the adhesive regions may provide larger available adhesive areas. In certain embodiments, the width W of the available adhesive area is at least about 1 inch, in other embodiments at least about 2 inches, in other embodiments at least 3 inches, and in other embodiments at least 8 inches.

Some adhesive articles of the present disclosure have a lower force of stretch debonding to make the adhesive article easier to remove (e.g., a force of between about 10 to about 100 oz/inch). Some adhesive articles of the present disclosure can have a higher force of stretch debonding as to permit handling the release tab by the user without accidental separation (e.g., a force of between about 100 and about 250 oz/inch). Some embodiments of the present disclosure have an average stretch debonding force of between about 10 and about 170 oz/inch. Some embodiments of the present disclosure have stretch debonding force of between about 15 and about 60 oz/0.625 inch.

The adhesive articles of the present disclosure can maintain the desired stretch debonding force over a larger available adhesive area and/or thickness ratio than previously contemplated. For instance, certain adhesive articles featuring a multilayer backing (or single layer film) described herein may exhibit a stretch debonding force/width of about 35 oz/inch on an available adhesive area of 8 square inches and a stretch debond force of about 150 oz. In comparison, the max stretch debond force for commercially available strips expanded to a similar available adhesive area could exceed 600 oz. Other adhesive articles of the present disclosure exhibit an average stretch debond force of less than 150 oz on an available adhesive area of 4 square inches.

The substantially reduced force necessary to remove a larger available adhesive area allows the adhesive articles of the present disclosure to be used in mounting or attaching progressively larger objects. In some embodiments, the adhesive article can withstand a load of up to 30 pounds. In some embodiments up to 25 pounds, up to 20 pounds, up to 15 pounds, and in yet other embodiments up to 10 pounds. In other embodiments, the adhesive article can withstand a load exceeding 30 pounds.

The adhesives used in the adhesive articles described herein can include any adhesive having the desired properties. In some embodiments, the adhesive is stretch releasable. As used herein, the term “stretch-releasable” means removable from the surface of an adherend by stretching in the direction of the bond plane to an elongation of greater than 50%. In some embodiments, the adhesive releases cleanly from the surface of an adherend when the adhesive article is stretched at an angle of about 35° or less from a surface of the adherend. In some embodiments, the stretch releasable adhesive releases from a surface of an adherend when the multilayer carrier is stretched at an angle of about 35° or less from the adherend surface such that there are substantially no traces of the adhesive left behind on the surface of the adherend.

In some embodiments, the stretch releasable adhesive is a pressure sensitive adhesive. A general description of useful pressure sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Any suitable composition, material or ingredient can be used in the pressure sensitive adhesive. Exemplary pressure sensitive adhesives utilize one or more thermoplastic elastomers, e.g., in combination with one or more tackifying resins.

Some exemplary stretch releasable adhesives that can be used in the adhesive articles described herein include, for example, those described in U.S. Pat. No. 6,569,521 or International Publications WO/2017/136188 or WO/2017/136219, each of which is incorporated herein in its entirety. In some embodiments, the adhesive layer includes one or more hydrocarbon block copolymers; and a polar phenolic tackifier comprising a phenolic moiety and having a hydroxyl value of between 20 to 130 and an acid value of less than 0.5. In some embodiments, the adhesive includes at least one of the polar phenolic tackifiers is a terpene phenol.

Some stretch releasable adhesives that can be used in the adhesive articles of the present disclosure have a glass transition temperature of about −125° C. to 20° C., as determined by dynamic mechanical analysis of the tan δ peak value. Some stretch releasable adhesives that can be used in the adhesive articles of the present disclosure have a storage modulus of about 400,000 Pa or less, or 300,000 or less at 25° C., as determined by dynamic mechanical analysis.

In some embodiments, the thickness of the stretch releasable adhesive on at least one of the first or second major surfaces of the multilayer carrier is about 1 μm to about 1 mm.

In some embodiments, the stretch releasable adhesives are tailored to achieve removal with no or minimal damage. Exemplary methods and articles for doing so are described in, for example, U.S. Pat. No. 6,835,452 and International Application Number (assigned to the present assignee): PCT/US2017/048654 and incorporated herein in its entirety.

In some embodiments, the adhesive article exhibits an elastic recovery of greater than 70% or greater than 80% or greater than 95% at 10% strain. In some embodiments, the adhesive article exhibits an elastic recovery of greater than 70% or greater than 80% or greater than 90% at 25% strain. In some embodiments, the adhesive article exhibits an elastic recovery of greater than 70% or greater than 80% or greater than 90% or greater than 95% at 50% strain. In some embodiments, the adhesive article exhibits an elastic recovery of greater than 50% or greater than 70% or greater than 95% at 100% strain.

In some embodiments, the backing and/or at least some of the backing layers are substantially optically clear. As used herein, the term “optically clear” means having a light transmission of at least about 50% and/or a haze of no greater than 40%. Some embodiments have a light transmission of at least about 75%. Some embodiments, have a haze of no greater than 20%. Some embodiments, have a haze of no greater than 20%. Both the light transmission and the haze of the carrier (or at least some of the layers thereof) can be determined using, for example, ASTM D1003-95.

In some embodiments, the adhesive article further includes a tab. The tab is an area that can be easily accessed by the user to assist in or begin to stretch release the adhesive article from the adherend. The removal tab can be tacky from the outermost adhesive layer or non-tacky by being covered by layers of stretch film, non-stretch film, release liner, or from detackified adhesive.

In some embodiments, the adhesive article further includes one or more release liners. The release liner can be, for example, on either or both of the major surfaces of the stretch releasable adhesive layers. The release liner protects the adhesive during manufacturing, transit, and before use. When the user desires to use the adhesive article, the user can peel or remove the release liner to expose the adhesive. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048, and incorporated herein. Preferred release liners are fluoroalkyl silicone polycoated paper. The release liners can be printed with lines, brand indicia, or other information.

In some embodiments, the adhesive article has a thickness that is between about 2 mil and about 40 mils. In some embodiments, the thickness is greater than 3 mil, greater than 4 mil, greater than 5 mils, greater than 8 mils, greater than 10 mils, greater than 12 mils, greater than 15 mils, or greater than 20 mils. In some embodiments, the thickness is less than 40 mils, less than 38 mils, less than 35 mils, less than 33 mils, less than 30 mils, less than 28 mils, less than 25 mils, less than 22 mils, or less than 20 mils.

Some adhesive articles of the present disclosure have excellent shear strength. Some embodiments of the present disclosure have a shear strength of greater than 1600 minutes as measured according to ASTM D3654-82. Some embodiments of the present disclosure have shear strength of greater than 10,000 minutes as measured according to ASTM D3654-82. Some other embodiments of the present disclosure have shear strength of greater than 100,000 minutes as measured according to ASTM D3654-82.

In some embodiments, a force of between about 1N and about 50N per inch width is required to strain the adhesive article 10% in tensile elongation as measured according to ASTM D638-14 and/or ASTM D412-06a. In some embodiments, a force of between about 2N and about 30N per inch width is required to strain the adhesive article 10% in tensile elongation as measured according to ASTM D638-14 and/or ASTM D412-06a. In some embodiments, a force of between about 3N and about 15N per inch width is required to strain the adhesive article 10% in tensile elongation as measured according to ASTM D638-14 and/or ASTM D412-06a.

Some embodiments further include a mounting device. Exemplary mounting devices include, for example, hooks, clips, and loops. Any of the following mounting devices can be used with the adhesive article of the present disclosure: Application Matter No. 77486US002 (assigned to the present assignee), U.S. Pat. No. 5,409,189 (Luhmann), U.S. Pat. No. 5,989,708 (Kreckel), U.S. Pat. No. 8,708,305 (McGreevy), U.S. Pat. No. 5,507,464 (Hamerski et al.), U.S. Pat. No. 5,967,474 (doCanto et al.), U.S. Pat. No. 6,082,686 (Schumann), U.S. Pat. No. 6,131,864 (Schumann), U.S. Pat. No. 6,811,126 (Johansson, et al.), U.S. Pat. No. D665,653, and U.S. Pat. No. 7,028,958 (Pitzen, et al.), all of which are incorporated by reference in their entirety herein.

In some embodiments, the adhesive article has an elongation at break of at least 400%. Some adhesive articles of the present disclosure have an elongation at break of between about 400% and about 1500% in at least one direction. In some embodiments, the stretch releasable article can be stretched at least 100 percent, at least 150 percent, at least 200 percent, at least 300 percent, at least 400 percent, or at least 500 percent without breaking. The stretch releasable layer and/or film can often be stretched up to 1500 percent, up to 1200 percent, up to 1000 percent, up to 800 percent, up to 750 percent, or up to 700 percent without breaking. These relatively large elongation values facilitate stretch releasing of the adhesive articles of the present disclosure after being adhered to a substrate.

Some adhesive articles of the present disclosure have a tensile strength at break sufficiently high so that the adhesive article will not rupture prior to being stretched and removed from an adherend at an angle of 35° or less.

In some embodiments, the adhesive article can further include a separable connector. Some exemplary separable connectors are described in, for example, U.S. Pat. Nos. 6,572,945; 7,781,056; 6,403,206; and 6,972,141, all of which are incorporated by reference in their entirety herein.

Due in part to the properties of the backing materials described herein, the adhesive articles of the present disclosure can be made to include many desired aspect ratios between length and width of the backing without deleterious affecting stretch release performance.

Methods of Making the Adhesive Articles

The adhesive articles described herein can be made in various ways. In some embodiments, the adhesive can be directly coated onto a major surface of the backing. In other embodiments, the adhesive can be formed as a separate layer (e.g., coated onto a release liner) and then laminated to the backing.

The adhesive can be prepared using a variety of common methods for preparing adhesives. For example, the adhesive composition can be coated onto a release liner, coated directly onto a backing, or formed as a separate layer (e.g., coated onto a release liner) and then laminated to a backing.

To improve adhesion of the adhesive composition to the backing, the backing can be pretreated prior to applying, e.g., coating or laminating, the adhesive composition on the backing. Examples of suitable treatments include corona discharge, plasma discharge, flame treatment, electron beam irradiation, ultraviolet (UV) radiation, acid etching, chemical priming and combinations thereof. The treatment can optionally be performed with a reactive chemical adhesion promoter including, e.g., hydroxyethylacrylate, or hydroxyethyl methacrylate, or another reactive species of low molecular weight.

In some embodiments, one or more of the backing or adhesive layers can be foamed, as is described herein.

Methods of Using the Adhesive Articles

The adhesive articles of the present disclosure can be used in various ways. In some embodiments, the adhesive article is applied, attached to, or pressed into an adherend. In this way, the adhesive article contacts the adherend. Where a release liner is present, the release liner is removed before the adhesive article is applied, attached to, or pressed into an adherend. In some embodiments, at least a portion of the adherend is wiped with alcohol before the adhesive article is applied, attached to, or pressed into an adherend.

To remove the adhesive article from the adherend, at least a portion of the adhesive article is stretched away from the adherend. In some embodiments, the angle of stretch is 35° or less. In embodiments where a tab is present, the user can grip the tab and use it to stretch release the adhesive article from the adherend.

The following examples describe some exemplary constructions of various embodiments of the adhesive articles and methods of making the adhesive articles described in the present application. The following examples describe some exemplary constructions and methods of constructing various embodiments within the scope of the present application. The following examples are intended to be illustrative, but are not intended to limit the scope of the present application.

### EXAMPLES

TABLE 1
Material and supplier information

| Material | Description | Supplier |
|---|---|---|
| KRATON G1657 | Linear triblock copolymer based | KRATON Corp., Houston, TX |
| | on styrene and ethylene/butylene | |
| | (SEBS) with a polystyrene | |
| | content of 13% | |
| KRATON G1730 | Copolymer based on styrene and | KRATON Corp., Houston, TX |
| | ethylene/propylene (SEPS) with | |
| | a polystyrene content of 21% | |
| KRATON D1114 | Linear triblock copolymer based | KRATON Corp., Houston, TX |
| | on styrene and isoprene (SIS) | |
| | with a polystyrene content of | |
| | 19% | |
| KRATON 1106 | Linear triblock copolymer based | KRATON Corp., Houston, TX |
| | on styrene and isoprene (SIS) | |
| | with polystyrene content of | |
| | 15%, and diblock (SI) content of | |
| | 17% | |
| VISTAMAXX 6102 | Polymer primarily of isotactic | ExxonMobil Corp., Houston, TX |
| | propylene with random ethylene | |
| | distribution (16 wt % ethylene) | |
| VISTAMAXX 3980 | Polymer primarily of isotactic | ExxonMobil Corp., Houston, TX |
| | propylene with random ethylene | |
| | distribution (8 wt % ethylene) | |
| OPTEMA TC120 | Ethylene methyl acrylate | ExxonMobil Corp., Houston, TX |
| | copolymer | |
| PP1024 | Polypropylene homopolymer | ExxonMobil Corp., Houston, TX |
| PP3445 | Polypropylene homopolymer | Exxon Mobil Corp., Houston, TX |
| ENGAGE 8450 Polyolefin | Ethylene-Octene Copolymer | Dow Chemical Co., Midland MI |
| Elastomer | | |
| ENGAGE 8200 Polyolefin | Ethylene-Octene Copolymer | Dow Chemical Co., Midland, MI |
| Elastomer | | |
| AFFINITY PL 1850G | Ethylene-Octene Copolymer | Dow Chemical Co., Midland MI |
| Polyolefin Plastomer | | |
| EXACT 8201 | Metallocene catalyzed ethylene | ExxonMobil Corp., Houston, TX |
| | octene alpha olefin copolymer | |
| SOLPRENE 1205 | Linear random-block styrene- | Dynasol Elastomers, Houston, TX |
| | butadiene copolymer having | |
| | 25% styrene content, 17.5% | |
| | present as a polystyrene block | |
| SOLPRENE 411 | 70/30 butadiene/styrene | Dynasol Elastomers, Houston, TX |
| | thermoplastic copolymer, | |
| | polymerized in solution and | |
| | having a radial structure | |
| PICCOLYTE A135 (PA 135) | Polyterpene resin | Pinova Inc., Brunswick, GA |
| CALSOL 5550 | Naphthenic oil | Calumet Specialty Products |
| | | Partners L.P., Indianapolis, IN |
| POLYSTER T160 (YS T160) | Terpene phenolic resin | Yasuhara Chemical Company, Ltd., |
| | | Fuchu-city, Hiroshima, Japan |
| COMMAND Foam | COMMAND adhesive strip (0.5 | 3M Company, St. Paul, MN |
| | inch width medium size, white, | |
| | foam based backing) | |
| COMMAND Clear | COMMAND adhesive strip (0.5 | 3M Company, St. Paul, MN |
| | inch width medium size, clear, | |
| | film based backing) | |
| TESA POWERSTRIP | TESA POWERSTRIP (standard | tesa SE, Norderstedt, Germany |
| | strip, size small) | |

### Test Methods

### Stretch Release Adhesion Test

Removability was evaluated by the following method. Test strips were applied to adherends by rolling down with a 15 lb. roller. Adhered samples were aged at 72° F. (22° C.), 50% relative humidity for 1 day before testing. The strips were peeled from the panel using an INSTRON universal testing machine with a crosshead speed of 30 in/min (76.2 cm/min) at an angle of 2 degrees. The release force was measured and the panels were observed to see if visible adhesive residue remained on the panel or damage occurred. At least 2 replicates were tested for each sample and the average values are reported in the Tables.

Tensile Test

The tensile test and the mechanical values listed below are modified from ASTM D638-14 and ASTM D412-06a.

The multilayer backings were cut using a razor into strips having a width of 1 in (2.54 cm) and a length of at least 6 in (15.2 cm). The strips were loaded onto an INSTRON (Norwood, Mass.) 5944 load frame with 225 lbs load cell and 1 KN pneumatic clamps (PN 2712-041) with a gauge length of 2 in (5.1 cm). Samples were pulled in tension at a strain rate of 1*min⁻¹ (crosshead speed of 2 inches per minute for the 2-inch gauge length) to a displacement of 12 inches (304.8 mm or 600% Strain) and subsequently unloaded at a strain rate of 5*min⁻¹ to the original gauge length. Load-Extension was collected and output by the INSTRON machine and converted to stress-strain by normalizing Force per Unit Cross-Section Area

$$( σ = \frac{F}{A} ) .$$

Determination of Modulus of Elasticity

The modulus of Elasticity was calculated from the tensile data collected using the procedure above as the slope (ratio of stress to strain) of the stress-strain curve in the linear-elastic region.

Determination of Yield Stress and Strain at Yield

The Yield Stress and Strain at Yield were determined from tensile data collected as described previously. The Yield Point (Stress and Strain where yield occurs) was determined using a 2% Strain Offset.

Determination of P50

The P50 value is the load (Force) attained at 50% strain determined from the tensile data collected as described above.

Determination of Non-Recoverable Strain

The non-recoverable strain value was attained from the tensile data collected as described above and represents the portion of the crosshead displacement that remains when the transducer load returns to 0 during the unloading portion of the tensile test. The value indicates the portion of the 600% strain that becomes slack in the tested sample.

Test Adherends

Drywall panels (obtained from Materials Company, Metzger Building, St. Paul, Minn.) were single coat primed with Sherwin Williams PREP-RITE Interior Latex Primer applied using a paint roller, followed by air drying for 24 hours at ambient conditions. The primed drywall panels were then painted with a single coating of Sherwin Williams DURATION Interior Acrylic Latex Ben Bone White Paint “SW Ben Bone” (Sherwin-Williams Company, Cleveland, Ohio) applied by paint roller, followed by air drying for at least 7 days at ambient conditions before use.

### Examples 1-13

Preparation of Film Backings

Multilayer film backings of Examples 1-11 were prepared by coextruding a sheet of elastomeric core material together with two skin layers, one on either side of the elastomeric core layer, using a continuous coextrusion process like that described for Example 3 in U.S. Pat. No. 5,501,679. Details of the multilayer film constructions are provided in Table 2.

The film backing of Example 13 was an 81 μm thick, single layer, extruded film of VISTAMAXX 6102. A 150 μm thick, single layer, extruded film of EXACT 8201 was also prepared as a Control film backing.

The multilayer film backing constructions are summarized in Table 2.

TABLE 2
Multilayer Film Constructions

| | | | | | Core | |
|---|---|---|---|---|---|---|
| | | | Core | Skin | Layer | Total |
| | | | Layer | Layer | to Skin | Film |
| | Core Layer | Skin Layer | Thickness | Thickness | Layer | Thickness |
| Example | Material | Material | (μm) | (μm) | Ratio | (μm) |
| 1 | KRATON | OPTEMA | 120 | 10 | 12/1 | 140 |
| | 1114 | TC120 | | | | |
| 2 | KRATON | OPTEMA | 112 | 15 | 7/1 | 142 |
| | 1114 | TC120 | | | | |
| 3 | KRATON | OPTEMA | 109 | 18 | 6/1 | 145 |
| | 1114 | TC120 | | | | |
| 4 | KRATON | OPTEMA | 94 | 14 | 7/1 | 122 |
| | 1114 | TC120 | | | | |
| 5 | KRATON | OPTEMA | 117 | 12 | 10/1 | 141 |
| | 1114 | TC120 | | | | |
| 6 | KRATON | OPTEMA | 90 | 9 | 10/1 | 108 |
| | 1114 | TC120 | | | | |
| 7 | KRATON | PP 3445 | 66 | 6.5 | 10/1 | 79 |
| | 1657 | | | | | |
| 8 | KRATON | ENGAGE | 81 | 8 | 10/1 | 97 |
| | 1657 | 8450 | | | | |
| 9 | KRATON | AFFINITY | 161 | 7 | 23/1 | 175 |
| | 1114 | 1850 | | | | |
| 10 | KRATON | ENGAGE | 88 | 2 | 44/1 | 92 |
| | 1106 | 8200 | | | | |
| 11 | KRATON | VISTAMAXX | 136 | 3 | 45/1 | 142 |
| | 1114 | 3980 | | | | |
| 12 | KRATON | AFFINITY | 109 | 8 | 14/1 | 125 |
| | 1114 | 1850 | | | | |

### Pressure Sensitive Adhesive Formulations

A pressure-sensitive adhesive formulation was prepared having a 1.85 ratio of SOLPRENE 411 to SOLPRENE 1205 as the elastomer component and 98 parts of PICCOLYTE A135 tackifier based on 100 parts of total elastomer, and 9.8 pph of CALSOL 5550 oil. All of the components were added to a glass jar along with toluene to make a solution of approximately 43% solids. The jar was sealed and the contents thoroughly mixed by placing the jar on a roller at about 2-6 rpm for at least 24 hours prior to coating.

### Preparation of Adhesive Films

An adhesive transfer tape was prepared by knife-coating the above pressure sensitive adhesive composition onto a paper liner web having a silicone release surface. The paper liner web speed was 2.75 meter/min. After coating, the web was passed through an oven 11 meters long (residence time 4 minutes total) having three temperature zones. The temperature in zone 1 (2.75 meter) was 57° C.; temperature in zone 2 (2.75 meter) was 71° C.; temperature in zone 3 (about 5.5 meter) was 82° C. The caliper of the dried adhesive was approximately 2.5-3.0 mils thick. The desired size and geometry of the transfer adhesive tape was die cut and the adhesive tape was then laminated to both sides of the film backing leaving 0.5 inch (1.27 cm) of exposed film that acted as a tab. Sample widths are provided in the Tables. Samples were at least 2 inches in length. Samples of the transfer adhesive were then laminated to one side of the film backing for stretch release testing. Stretch Release data are shown in Tables 3-5.

TABLE 3
Stretch Release Test Data

| | | Max | Average |
|---|---|---|---|
| | Sample Width | force/width | Force/width |
| Example | (in) | (oz/in) | (oz/in) |
| 1 | 0.625 | 51.0 | 40.0 |
| 1 | 8 | 42.1 | 34.5 |
| 2 | 0.625 | 59.0 | 44.3 |
| 2 | 2 | 64.2 | 52.3 |
| 3 | 0.625 | 65.2 | 51.5 |
| 3 | 2 | 67.6 | 56.2 |
| 3 | 4 | 65.1 | 50.7 |
| 4 | 0.625 | 65.6 | 40.2 |
| 4 | 2 | 73.4 | 51.8 |
| 4 | 4 | 61.6 | 52.7 |
| 5 | 0.625 | 46.6 | 36.9 |
| 5 | 2 | 48.4 | 41.8 |
| 5 | 8 | 41.2 | 32.4 |
| 12 | 0.625 | 31.6 | 22.6 |
| COMMAND Clear | 0.625 | 101.9 | 96.7 |
| COMMAND Foam | 0.625 | 122.2 | 118.1 |
| TESA POWERSTRIP | | 80.5 | 72.7 |

TABLE 4
Stretch Release Test Data

| | Sample Width | Max force | Average Force |
|---|---|---|---|
| Example | (in) | (oz) | (oz) |
| 1 | 0.625 | 44.1 | 36.1 |
| 1 | 8 | 336.6 | 275.8 |
| 2 | 0.625 | 48.6 | 38.5 |
| 2 | 2 | 128.4 | 104.7 |
| 3 | 0.625 | 50.3 | 40.8 |
| 3 | 2 | 135.1 | 112.4 |
| 3 | 4 | 260.5 | 202.9 |
| 4 | 0.625 | 37.0 | 26.4 |
| 4 | 2 | 146.8 | 103.7 |
| 4 | 4 | 246.4 | 210.6 |
| 5 | 0.625 | 29.1 | 23.0 |
| 5 | 2 | 96.8 | 83.6 |
| 5 | 8 | 329.6 | 259.3 |
| 6 | 0.625 | 25.4 | 20.0 |
| 6 | 2 | 78.9 | 71.8 |
| 6 | 4 | 168.4 | 149.1 |
| 7 | 0.625 | 31.0 | 21.0 |
| 7 | 2 | 81.8 | 60.2 |
| 7 | 8 | 499.0 | 394.2 |
| 8 | 0.625 | 36.7 | 29.8 |
| 8 | 2 | 132.3 | 104.0 |
| 8 | 4 | 247.1 | 202.2 |
| 8 | 8 | 474.6 | 439.5 |
| 9 | 0.625 | 35.5 | 28.3 |
| 9 | 2 | 142.8 | 109.9 |
| 9 | 4 | 242.5 | 208.8 |
| 10 | 2 | 73.1 | 61.0 |
| 11 | 0.625 | 30.2 | 22.5 |
| 11 | 2 | 92.1 | 76.4 |
| 11 | 4 | 179.8 | 156.9 |
| 13 | 0.625 | 34.9 | 26.3 |
| 13 | 2 | 106.3 | 93.5 |
| 13 | 8 | 406.5 | 337.7 |
| Control film | 0.625 | 79.8 | 70.6 |
| TESA POWERSTRIP | 2 | 161.0* | 145.4* |
| TESA POWERSTRIP | 4 | 322.0* | 290.9 |
| TESA POWERSTRIP | 8 | 644.1* | 581.8* |
| COMMAND Foam | 2 | 244.4* | 236.1* |
| COMMAND Foam | 4 | 488.7* | 472.2* |
| COMMAND Foam | 8 | 977.5* | 944.4* |
| COMMAND Clear | 2 | 203.8* | 193.4* |
| COMMAND Clear | 4 | 407.6* | 386.7* |
| COMMAND Clear | 8 | 815.1* | 773.5* |

*Values were calculated based on theoredtical width of strip and debond force measured from commercially available product

TABLE 5
Stretch Release Test Data

| | Sample | Sample | Adhesive | Debond | Debond |
|---|---|---|---|---|---|
| | Width | Length | Area | Force | Force/width |
| Example | (in) | (in) | (in²) | (oz) | (oz/in) |
| 6 | 0.625 | 2 | 1.25 | 20.0 | 32.0 |
| 6 | 2 | 2 | 4 | 71.8 | 35.9 |
| 6 | 4 | 2 | 8 | 149.1 | 37.3 |
| 13 | 0.625 | 2 | 1.25 | 26.3 | 42.2 |
| 13 | 2 | 2 | 4 | 93.5 | 46.7 |
| 13 | 8 | 8 | 64 | 337.7 | 42.2 |

Table 5 shows how the impact of strip width effects accessable adhesive size, and keeps the debond force significantly lower than current commericially available products, dramatically increasing the holding power of a single adhesive pad based on adhesive surface area.

Table 6 shows mechanical property data was also obtained on the film examples using the Tensile Test procedure described above.

TABLE 6
Mechanical Properties

| | | | | | Non- |
|---|---|---|---|---|---|
| | Modulus of | Yield | Strain | | recoverable |
| | Elasticity | Stress | at Yield | P50 | Strain |
| Example | (kPa) | (kPa) | (%) | (N/in) | (%) |
| 1 | 6700 | 520 | 11 | 3.52 | 9.8 |
| 2 | 13300 | 800 | 8 | 5.2 | 16.7 |
| 3 | 15000 | 900 | 8.5 | 6.04 | 18.9 |
| 4 | 17500 | 1000 | 7.5 | 5.2 | 18.9 |
| 5 | 6000 | 500 | 11 | 2.97 | 10.7 |
| 6 | 6250 | 400 | 9 | 2.22 | 10.2 |
| 7 | 115000 | 2400 | 4.5 | 4.86 | 15.5 |
| 8 | 18000 | 1100 | 8 | 5.03 | 15.1 |
| 9 | 8300 | 520 | 9 | 4.12 | 6.6 |
| 10 | 2200 | 190 | 12 | 1.29 | 5.8 |
| 11 | 6250 | 330 | 7 | 2.53 | 5.1 |
| 12 | 4300 | 240 | 7.5 | 1.67 | 13.5 |
| 13 | 11250 | 1000 | 11 | 4.12 | 21.0 |
| Control | 32400 | 2500 | 10.5 | 14.90 | 62.0 |
| film | | | | | |

### Examples 14-36

Additional multilayer film constructions that are useful as backings in the present invention were prepared as described above and are provided in Table 7. Mechanical properties of some of the films except that the samples were pulled to a displacement of 400% Strain. The results are provided in Table 8.

TABLE 7
Multilayer Film Constructions

| | | | | | Core | |
|---|---|---|---|---|---|---|
| | | | | | Layer to | |
| | | | Core Layer | Skin Layer | Skin | Total Film |
| | Core Layer | Skin Layer | Thickness | Thickness | Layer | Thickness |
| Example | Material | Material | (μm) | (μm) | Ratio | (μm) |
| 14 | KRATON | PP1024 | 79 | 8 | 10/1 | 95 |
| | 1730 | | | | | |
| 15 | KRATON | ENGAGE 8450 | 204 | 24 | 9/1 | 252 |
| | 1657 | | | | | |
| 16 | KRATON | ENGAGE 8450 | 174 | 9 | 19/1 | 192 |
| | 1657 | | | | | |
| 17 | KRATON | PP1024 | 75 | 8 | 9/1 | 91 |
| | 1730 | | | | | |
| 18 | KRATON | AFFINITY | 131 | 10 | 13/1 | 151 |
| | 1657 | 1850 | | | | |
| 19 | KRATON | AFFINITY | 155 | 9 | 15/1 | 173 |
| | 1657 | 1850 | | | | |
| 20 | KRATON | AFFINITY | 121 | 6 | 20/1 | 133 |
| | 1657 | 1850 | | | | |
| 21 | KRATON | AFFINITY | 131 | 5.5 | 24/1 | 142 |
| | 1657 | 1850 | | | | |
| 22 | KRATON | ENGAGE 8450 | 70 | 10 | 7/1 | 90 |
| | 1114 | | | | | |
| 23 | KRATON | ENGAGE 8450 | 109 | 16 | 7/1 | 141 |
| | 1114 | | | | | |
| 24 | KRATON | AFFINITY | 101 | 13 | 8/1 | 127 |
| | 1114 | 1850 | | | | |
| 25 | KRATON | AFFINITY | 228 | 12 | 19/1 | 252 |
| | 1114 | 1850 | | | | |
| 26 | KRATON | ENGAGE 8450 | 429 | 39 | 11/1 | 507 |
| | 1657 | | | | | |
| 27 | KRATON | ENGAGE 8450 | 125 | 11 | 11/1 | 147 |
| | 1657 | | | | | |
| 28 | KRATON | ENGAGE 8450 | 93 | 4 | 23/1 | 101 |
| | 1657 | | | | | |
| 29 | KRATON | ENGAGE 8450 | 464 | 17 | 27/1 | 499 |
| | 1657 | | | | | |
| 30 | KRATON | ENGAGE 8450 | 144 | 9 | 16/1 | 162 |
| | 1657 | | | | | |
| 31 | KRATON | ENGAGE 8450 | N/A (Foam) | N/A (Foam) | N/A | 725 |
| | 1657 | | | | (Foam) | |
| 32 | KRATON | VISTAMAXX | 136 | 3 | 45/1 | 142 |
| | 1114 | 3980 | | | | |
| 33 | KRATON | OPTEMA | 120 | 10 | 12/1 | 140 |
| | 1114 | TC120 | | | | |
| 34 | KRATON | OPTEMA | 109 | 18 | 6/1 | 145 |
| | 1114 | TC120 | | | | |
| 35 | KRATON | ENGAGE 8200 | 88 | 2 | 44/1 | 92 |
| | 1106 | | | | | |
| 36 | KRATON | AFFINITY | 109 | 8 | 14/1 | 125 |
| | 1114/ | 1850 | | | | |
| | POLYSTER | | | | | |
| | T160 (70 | | | | | |
| | PPH) | | | | | |

TABLE 8
Mechanical Properties

| | Modulus of | Secant | Yield | Strain | |
|---|---|---|---|---|---|
| | Elasticity | Modulus | Stress | at Yield | P50 |
| Example | (kPa) | (kPa) | (kPa) | (%) | (N/in) |
| 14 | 187000 | 165000 | 4000 | 3.0 | 9.0 |
| 16 | 9000 | 9000 | 550 | 8.0 | 6.5 |
| 17 | 6000 | 6000 | 400 | 9.0 | 10.5 |
| 18 | 8500 | 8500 | 480 | 7.5 | 5.0 |
| 19 | 8500 | 8500 | 500 | 8.0 | 5.5 |
| 20 | 8500 | 8500 | 500 | 8.0 | 4.5 |
| 21 | 8500 | 8500 | 530 | 8.5 | 4.0 |
| 26 | 13500 | 13500 | 880 | 8.5 | 20.5 |
| 27 | 12000 | 12000 | 610 | 7.0 | 5.5 |
| 28 | 7500 | 7500 | 470 | 8.5 | 3.0 |
| 29 | 7500 | 7500 | 500 | 9.5 | 14.5 |
| 30 | 10000 | 10000 | 530 | 8.5 | 4.0 |
| 31 | 500 | 500 | 100 | 20.0 | 3.0 |
| 32 | 7500 | 6800 | 350 | 7.5 | 2.5 |
| 33 | 6900 | 6400 | 550 | 12.0 | 3.4 |
| 34 | 15000 | 14200 | 850 | 8.0 | 5.4 |
| 35 | 2000 | 1700 | 200 | 14.0 | 1.0 |
| 36 | 4400 | 4300 | 240 | 7.5 | 1.6 |

Reference throughout this specification to “one embodiment,” “some embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

### Embodiments

1. An adhesive article, comprising: a multilayer backing comprising: a core layer comprising at least one of an elastomeric material, an elastomeric polymer, SEBS, SEPS, SIS, SBS, polyurethane, ethyl vinylacetate (EVA), ethyl methyl acrylate (EMA), ultra low linear density polyethylene (ULLDPE), hydrogenated polypropylene, and combinations or blends thereof; a first skin layer comprising at least one of polypropylene, polyethylene, high density polyethylene (HDPE), low density polyethylene (LDPE), linear low density polyethylene (LLDPE), a polyurethane, EVA, EMA, and combinations or blends thereof; and an adhesive adjacent to a major surface of the multilayer backing; wherein the backing has a core to skin ratio of between about 2:1 and about 50:1 and wherein the backing has a modulus of elasticity and/or a modulus of secant of between about 100 psi and about 18,000 psi as determined by at least one of ASTM D638-14 and ASTM D412-06a.

2. The adhesive article of embodiment 1, further comprising: a second skin layer comprising at least one of polypropylene, polyethylene, high density polyethylene (HDPE), low density polyethylene (LDPE), linear low density polyethylene (LLDPE), a polyurethane, EVA, and combinations or blends thereof.

3. The adhesive article of any of the preceding embodiments, wherein the backing has a thickness of between about 2 mils and about 40 mils.

4. The adhesive article of any of the preceding embodiments, wherein a force of between about 1N and about 50N per inch width results in at 10% strain in tensile elongation as measured according to ASTM D638-14 and/or ASTM D412-06a.

5. The adhesive article of any of the preceding embodiments, wherein the core has a tensile and/or elastic modulus of between about 50 psi and about 5000 psi as measured according to ASTM D638.

6. The adhesive article of any of the preceding embodiments, wherein at least one of the first or second skin layer has an elastic and/or secant modulus of between about 3000 psi and about 300,000 psi as measured according to ASTM D638.

7. The adhesive article of any of the preceding embodiments, wherein the core comprises at least one of SEBS, SIS, or SBS.

8. The adhesive article of any of the preceding embodiments, wherein the core and/or first or second skin layer further including at least one of a tackifier, a plasticizer, a plasticizing oil, a UV inhibitor, and/or an antioxidant.

9. The adhesive article of any of the preceding embodiments, wherein the first skin comprises at least one of polypropylene or polyethylene; and wherein the second skin comprises at least one of polypropylene or polyethylene.

10. The adhesive article of any of the preceding embodiments, wherein the adhesive includes at least one of SBS, SBR, SIS, SEBS, acrylate, and/or polyurethane.

11. The adhesive article of any of the preceding embodiments, wherein the adhesive includes at least one of the following tackifiers: polyterpene, terpene phenol, rosin esters, hydrocarbons, C5 resins, C9 resins, and/or rosin acids.

12. The adhesive article of any of the preceding embodiments, wherein the adhesive includes at least one of hydrocarbon block copolymers, silicone block copolymers, and combinations thereof.

13. The adhesive article of any of the preceding embodiments 1-11, wherein the adhesive is stretch releasable and includes at least one of an acrylate, a polyurethane, a tackified rubber adhesives, such as natural rubber; olefins; silicones, such as silicone polyureas; synthetic rubber adhesives such as polyisoprene, polybutadiene, and styrene-isoprene-styrene, styrene-ethylene-butylene-styrene and styrene-butadiene-styrene block copolymers, SBR, SEBS, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations thereof.

14. The adhesive article of any of the preceding embodiments, wherein the adhesive has a Tg of between about −125 degrees Celsius and about 20 degrees Celsius.

15. The adhesive article of any of the preceding embodiments, wherein the adhesive has a storage modulus of about 400,000 Pa or less at 25° C., as determined by dynamic mechanical analysis.

16. An adhesive article, comprising: a backing comprising: a core layer comprising at least one of an elastomeric material, an elastomeric polymer, SEBS, SEPS, SIS, SBS, polyurethane, ethyl vinylacetate (EVA), EMA, ultra low linear density polyethylene (ULLDPE), hydrogenated polypropylene, and combinations or blends thereof; and an adhesive adjacent to a major surface of the backing; wherein the backing has a modulus of elasticity and/or a modulus of secant of between about 100 psi and about 18,000 psi as determined by at least one of ASTM D638-14 and ASTM D412-06a.

17. The adhesive article of embodiment 16, wherein the backing is a multilayer backing, and wherein the backing further comprises a first skin layer comprising at least one of polypropylene, polyethylene, high density polyethylene (HDPE), low density polyethylene (LDPE), linear low density polyethylene (LLDPE), a polyurethane, EVA, EMA, and combinations or blends thereof.

18. The adhesive article of embodiment 16 or 17, wherein the backing has a core to skin ratio of between about 2:1 and about 300:1.

19. The adhesive article of embodiment 18, wherein the backing has a core to skin ratio of between about 4:1 and about 150:1.

20. The adhesive article of embodiment 19, wherein the adhesive is a stretch releaseable adhesive.

21. The adhesive article of embodiment 20, wherein the stretch releasable adhesive releases from a surface of an adherend when the backing is stretched at an angle of about 35° or less from the adherend surface such that there are substantially no traces of the stretch releasable adhesive left behind on the surface of the adherend.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

All references mentioned herein are hereby incorporated by reference in their entirety.

With reference to the Figures, like numerals are used to designate like components throughout the set of Figures.

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

What is claimed is:

1. A stretch release adhesive article, comprising:
a multilayer backing comprising:
a core layer comprising at least one of an elastomeric material, an elastomeric polymer, SEBS, SEPS, SIS, SBS, polyurethane, ethyl vinylacetate (EVA), ethyl methyl acrylate (EMA), ultra low linear density polyethylene (ULLDPE), hydrogenated polypropylene, and combinations or blends thereof;
a first skin layer comprising at least one of polypropylene, polyethylene, high density polyethylene (HDPE), low density polyethylene (LDPE), linear low density polyethylene (LLDPE), a polyurethane, EVA, EMA, and combinations or blends thereof; and
a stretch-releasable adhesive adjacent to a major surface of the multilayer backing;
wherein the backing has a core to skin ratio of between about 2:1 and about 50:1 and
wherein the backing has a modulus of elasticity and/or a modulus of secant of between about 100 psi and about 18,000 psi as determined by at least one of ASTM D638-14 and ASTM D412-06a.

2. The adhesive article of claim 1, further comprising:
a second skin layer comprising at least one of polypropylene, polyethylene, high density polyethylene (HDPE), low density polyethylene (LDPE), linear low density polyethylene (LLDPE), a polyurethane, EVA, and combinations or blends thereof.

3. The adhesive article of claim 1, wherein the backing has a thickness of between about 2 mils and about 40 mils.

4. The adhesive article of claim 1, wherein a force of between about 1N and about 50N per inch width results in at 10% strain in tensile elongation as measured according to ASTM D638-14 and/or ASTM D412-06a.

5. The adhesive article of claim 1, wherein the core has a tensile and/or elastic modulus of between about 50 psi and about 5000 psi as measured according to ASTM D638.

6. The adhesive article of claim 1, wherein at least one of the first or second skin layer has an elastic and/or secant modulus of between about 3000 psi and about 300,000 psi as measured according to ASTM D638.

7. The adhesive article of claim 1, wherein the core comprises at least one of SEBS, SIS, or SBS.

8. The adhesive article of claim 1, wherein the core and/or first or second skin layer further including at least one of a tackifier, a plasticizer, a plasticizing oil, a UV inhibitor, and/or an antioxidant.

9. The adhesive article of claim 1, wherein the first skin comprises at least one of polypropylene or polyethylene; and
wherein the second skin comprises at least one of polypropylene or polyethylene.

10. The adhesive article of claim 1, wherein the adhesive includes at least one of SBS, SBR, SIS, SEBS, acrylate, and/or polyurethane.

11. The adhesive article of claim 1, wherein the adhesive includes at least one of the following tackifiers: polyterpene, terpene phenol, rosin esters, hydrocarbons, C5 resins, C9 resins, and/or rosin acids.

12. The adhesive article of claim 1, wherein the adhesive includes at least one of hydrocarbon block copolymers, silicone block copolymers, and combinations thereof.

13. The adhesive article of claim 1, wherein the adhesive is stretch releasable and includes at least one of an acrylate, a polyurethane, a tackified rubber adhesives, such as natural rubber; olefins; silicones, such as silicone polyureas; synthetic rubber adhesives such as polyisoprene, polybutadiene, and styrene-isoprene-styrene, styrene-ethylene-butylene-styrene and styrene-butadiene-styrene block copolymers, SBR, SEBS, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations thereof.

14. A stretch release adhesive article, comprising:
a multilayer backing comprising:
a core layer comprising at least one of an elastomeric material, an elastomeric polymer, SEBS, SEPS, SIS, SBS, polyurethane, ethyl vinylacetate (EVA), EMA, ultra low linear density polyethylene (ULLDPE), hydrogenated polypropylene, and combinations or blends thereof,
and a first skin layer comprising at least one of polypropylene, polyethylene, high density polyethylene (HDPE), low density polyethylene (LDPE), linear low density polyethylene (LLDPE), a polyurethane, EVA, EMA, and combinations or blends thereof; and
a stretch releasable adhesive adjacent to a major surface of the backing and defining an available adhesive area;
wherein the backing has a modulus of elasticity and/or a modulus of secant of between about 100 psi and about 18,000 psi as determined by at least one of ASTM D638-14 and ASTM D412-06a,
and wherein the available adhesive area is at least about 10 square centimeters.

15. The adhesive article of claim 14, wherein the available adhesive area is at least about 100 square centimeters.

16. (canceled)

17. The adhesive article of claim, wherein the backing has a core to skin ratio of between about 2:1 and about 300:1.

18. The adhesive article of claim 17, wherein the backing has a core to skin ratio of between about 4:1 and about 150:1.

19. The adhesive article of claim 14, wherein the stretch releasable adhesive releases from a surface of an adherend when the backing is stretched at an angle of about 35° or less from the adherend surface such that there are substantially no traces of the stretch releasable adhesive left behind on the surface of the adherend.

20. (canceled)
